(19) United States
(12) Patent Application Publication
(10) Pub. No.: US 2009/0070158 A1
(43) Pub. Date: Mar. 12, 2009

(54) METHOD APPARATUS AND SYSTEM FOR VISUALIZATION OF PROBABILISTIC MODELS

(75) Inventors: Lev Virine, Calgary (CA); Jason McVean, Calgary (CA)

Correspondence Address: Schlumberger Technology Corporation/Osha Liang;Mr. Bryan Galloway, Managing IP Counsel, 5599 San Felipe, Suite 100, HOUSTON, TX, 77056, US

(73) Assignee: SCHLUMBERGER TECHNOLOGY CORPORATION, Houston, TX (US)

(21) Appl. No.: 11/632,003

(22) PCT Filed: Aug. 2, 2005
(86) PCT No.: PCT/US2005/027297

§ 371 Date: Nov. 14, 2008

Related U.S. Application Data
(60) Provisional application No. 60/598,021, filed on Aug. 2, 2004.

(51) Int. Cl. G06Q 10/00

(52) U.S. Cl. 705/7

(57) ABSTRACT

A method, apparatus, computer system and a program storage device for modeling a business process to assess risk is provided. A preferred embodiment of the method includes the steps of: (a) creating a high level model for the business process, (b) modeling a calculation algorithm for the business process; and (c) testing the model; wherein one or more views are used in each of steps (a), (b) and (c); and wherein the pattern technique of identifying and visualizing uncertainty is used in each of steps (a), (b) and (c), in increasing detail at each successive step.

### CROSS REFERENCE TO RELATED APPLICATIONS

This is a utility application of prior pending provisional application serial numbered 60/598,021 filed Aug. 2, 2004, and entitled The Method of The Visualization of Probabilistic Models.

### BACKGROUND OF THE INVENTION

1. Field of the Invention

This invention relates to methods, apparatuses and systems for use in area of quantified business analysis, particularly for complex business analysis. More specifically, the invention provides methods, apparatuses and systems for more effectively and efficiently modeling business problems for performing economic and fiscal evaluation, decision and risk analysis, forecasting and scheduling, portfolio management, and product lifecycle management.

2. Background of the Invention

Effective analysis of complex business processes requires powerful and easy-to-use computer-based tools, including economic evaluation and analysis such as fiscal modeling, decision and risk analysis, forecasting, scheduling, portfolio management, quantified market analysis, and others. (See Van Vliet, B. and Hendry, R., 2004, Modeling Financial Markets: Using Visual Basic.NET and Databases to Create Pricing. Trading, and Risk Management Models, New York, N.Y.: McGraw Hill, 2004).

There are currently at least three distinct approaches to the creation and implementation of tools for business analysis. The first approach is based on spreadsheet applications. One of main advantages of spreadsheet approach is flexibility: calculations can be implemented without creation a computer application; models can be easy updated and executed with different data sets; modeling in spreadsheets does not required advanced knowledge of computer programming; data can be easy visualized in standard tabular and graphical formats. Spreadsheet applications can also support scripting languages, which can be used for more complex models. Finally there is a number of business analysis add-ins built to operate seamlessly with spreadsheet applications.

While spreadsheets sometimes prove to be effective modeling tools for small and medium size business processes, there are a number of problems associated with the use of spreadsheets for complex business analysis. For instance, data and calculation algorithms are not presented simultaneously, making it difficult to understand and troubleshoot large spreadsheets. Furthermore, the visualization of relationships between variables in spreadsheets is limited. Finally, spreadsheet applications have limited interface tools to design and present user forms for data input and output.

Another approach in implementing business analysis tools is to create specialized computer applications for a particular model or a group of models. In this case the model or the interface associated with the model cannot be easily updated without updating the application. However, specialized applications are in most cases easier to use than spreadsheets because the user interface and calculation are optimized for the particular problem.

The third approach to the implementation of tools for business analysis is the integrated solution framework. Such frameworks offer a flexible environment where business models can be easy created and maintained, user interaction is simplified, and data from multiple sources can be accessed seamlessly. There are number of large and comprehensive enterprise resource planning systems, such as SAP, PeopleSoft, Siebel, I2, and Oracle. (See Andersen, G., SAP Planning: Best Practices in Implementation, SAMS Publishing, 2003.)

These systems are capable of solving a wide variety of business problems. Such systems have a large number of components, which are built around a common framework based on common architectural concept. A solution can be built using these components as building blocks for the particular problem using customer-defined processes and data. Such solution frameworks are designed for complex repeatable processes within the organization. However, they are sometimes not efficient tools for stand-alone business analysis problems, especially if the framework is not yet enabled across the organization.

There is also another class of business analysis and simulation frameworks, which be can easy customized to solve different business problems. Examples of such solutions include Analytica by Lumina Data Systems, Extend by ImagineThat Inc. (see Krahl, D., “Modeling with Extend,” published in Proceedings of 1999 Winter Simulation Conference, Phoenix, Ariz., 1999), GoldSim and GoldSim technology group, Enterprise Optimizer by River Logic Inc., and others. These tools allow the user to create a model of the business process, create a user form to input data and present the output, access data in different formats, and provide different kinds of simulations. These systems represent a significant step forward beyond spreadsheets and spreadsheet's add-ins. However, there are a number of problems associated with such systems, as discussed in Paul R. J. and Serrano A., “Simulation for Business Processes and Information Systems Design” published in Proceedings of 2003 Winter Simulation Conference, New Orleans, La., 2003. Each of the applications uses its own visualization approach to represent the model and simulation algorithm, as discussed in Virine, L. and Rapley, L., “Visualization of Probabilistic Business Models,” published in Proceedings of 2003 Winter Simulation Conference, New Orleans, La. 2003. Due to the lack of visualization standards, the modelers and the users can have difficulty reading and understanding the model created by another application. Although the applications mentioned above are focused on different problems, the modeling workflow is similar. However these applications represent and communicate the workflow differently, often using non-standard terminology. Finally the visualization of certain workflow steps such as calculation logic, testing, and consolidation remains a challenge.

### SUMMARY OF THE INVENTION

In view of the above problems, an object of the present invention is to provide methods, apparatuses and systems for a scalable visual modeling workflow for business analysis problems while eliminating or minimizing the impact of the problems and limitations described.

In one aspect, the invention comprises a method of creating models for a business process to help assess risk, comprising the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step. In some embodiments of the invention, at least a second pattern technique may be used during at least one of steps (a), (b) and (c) of the process. Some embodiments of the invention may include the additional step of consolidating the modeling. Some embodiments of the invention may include the additional step of decision toolbox with the model created. In some embodiments of the invention, step a) of creating the high level model for the business process may be performed using a conceptual view, a data source definition view or a workflow view. In some embodiments of the invention, step b) of modeling a calculation algorithm for the business process is performed using a domain model view, a calculation diagram, or a calculation script. The calculation diagram may have one of more layers. The calculation diagram used may be generated using the following steps: (i) defining global calculation parameters; (ii) defining one or more input variables and one or more output variables; (iii) defining the calculation algorithm; (iv) testing the calculation algorithm; and (vi) generating a user interface form. The user interface form may be that of a dashboard. In some embodiments, step b may be performed by using a calculation script and by also using a domain script or a calculation diagram. In some embodiments of the invention, step c) of testing the model may be performed using one or more sensitivity charts or a testing process diagram.

In another aspect, the invention comprises a method of creating models for a business process to help assess risk, comprising the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step, in which at least a second pattern technique is used during at least one of steps (a), (b) and (c) of the process and wherein step a) of creating the high level model for the business process is performed using a conceptual view, a data source definition view or a workflow view. Another embodiment of the invention comprises a method of creating models for a business process to help assess risk, comprising the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step, in which at least a second pattern technique is used during at least one of steps (a), (b) and (c) of the process and wherein step b) of modeling a calculation algorithm for the business process may be performed using a domain model, a calculation diagram or a calculation script. The calculation diagram may have one or more layers. The calculation diagram used may be generated using the following steps: (i) defining global calculation parameters; (ii) defining one or more input variables and one or more output variables; (iii) defining the calculation algorithm; (iv) testing the calculation algorithm; and (v) generating a user interface form. Another embodiment of the invention comprises a method of creating models for a business process to help assess risk, comprising the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step, in which at least a second pattern technique is used during at least one of steps (a), (b) and (c) of the process and wherein step c) of testing the model is performed using one or more sensitivity charts or a testing process diagram.

In certain embodiments of the invention having the step of using tools from a decision toolbox with the model generated, tools from the decision toolbox may include used is a sensitivity analysis visual tool, a decision analysis tool such as a decision tree, a Monte Carlo simulation or a discrete simulation visualization.

In certain embodiments of the invention wherein a second pattern technique is used in at least one of steps a, b, or c, the second pattern technique may include decoupling, encapsulation, a user workflow visualization or a multi-layer representation of calculation logic.

In another aspect, the invention includes a program storage device readable by a machine, tangibly embodying a program of instructions executable by the machine to perform method steps for creating a model of a business process, said method steps comprising: (a) creating a high level model for the business process, (b) modeling a calculation algorithm for the business process; and (c) testing the model; and wherein one or more views are used in each of steps (a), (b) and (c); and wherein a pattern technique of identifying and visualizing uncertainty is used in each of steps (a), (b) and (c), in increasing detail at each successive step. A second pattern technique may be used during at least one of steps (a), (b) or (c) of the process. The method steps may also include a further step of consolidating the modeling and/or of using one or more tools from a decision toolbox with the model created. Step a) of creating a high level model for the business process may be performed using a conceptual view, a data source definition view, or a workflow view. Step b) of modeling a calculation algorithm for the business process may be performed using a domain model, a calculation diagram and/or a calculation script. The calculation diagram used may have one or more layers and may be generated using the following steps: (i) defining global calculation parameters; (ii) defining one or more input variables and one or more output variables; (iii) defining the calculation algorithm; (iv) testing the calculation algorithm; and (v) generating a user interface form. The user interface form may be that of a dashboard. Step c) of testing the model may be performed using one or more sensitivity charts or a testing process diagram.

In another aspect, the invention includes a program storage device readable by a machine, tangibly embodying a program of instructions executable by the machine to perform method steps for creating a model of a business process, said method steps comprising: (a) creating a high level model for the business process, (b) modeling a calculation algorithm for the business process; and (c) testing the model; wherein one or more views are used in each of steps (a), (b) and (c); and wherein a pattern technique of identifying and visualizing uncertainty is used in each of steps (a), (b) and (c), in increasing detail at each successive step, and wherein a second pattern technique is used during at least one of steps (a), (b) or (c) of the process. The method steps may also include a further step of consolidating the modeling and/or of using one or more tools from a decision toolbox with the model created. Step a) of creating a high level model for the business process may be performed using a conceptual view, a data source definition view, or a workflow view. Step b) of modeling a calculation algorithm for the business process may be performed using a domain model, a calculation diagram and/or a calculation script. The calculation diagram used may have one or more layers and may be generated using the following steps: (i) defining global calculation parameters; (ii) defining one or more input variables and one or more output variables; (iii) defining the calculation algorithm; (iv) testing the calculation algorithm; and (v) generating a user interface form. The user interface form may be that of a dashboard. Step c) of testing the model may be performed using one or more sensitivity charts or a testing process diagram.

In aspects of the invention including a program storage device readable by a machine, tangibly embodying a program of instructions executable by the machine to perform method steps for creating a model of a business process, said method steps comprising: (a) creating a high level model for the business process, (b) modeling a calculation algorithm for the business process; and (c) testing the model; wherein one or more views are used in each of steps (a), (b) and (c); and having the further method step of using one or more tools from a decision toolbox with the model created, the tools may include a sensitivity analysis visual tool, a decision analysis tool (such as a decision tree), a Monte Carlo simulation or a discrete simulation visualization.

In another aspect, the invention includes a program storage device readable by a machine, tangibly embodying a program of instructions executable by the machine to perform method steps for creating a model of a business process, said method steps comprising: (a) creating a high level model for the business process, (b) modeling a calculation algorithm for the business process; and (c) testing the model; wherein one or more views are used in each of steps (a), (b) and (c); and wherein a pattern technique of identifying and visualizing uncertainty is used in each of steps (a), (b) and (c), in increasing detail at each successive step, and wherein a second pattern technique is used during at least one of steps (a), (b) or (c) of the process, the second pattern technique may include decoupling, encapsulation, a user workflow visualization, or a multi-layer representation of calculation logic.

In another aspect of the invention, an apparatus for modeling a business process is provided, including (a) a first means for creating a high level model for the business process, (b) a second means for modeling a calculation algorithm for the business process; and (c) a testing means for testing the model; wherein one or more views are used by the first means, the second means and the testing means; and wherein the first means, the second means and the third means each use a pattern technique to identify and visualize uncertainty and wherein the second means is capable of identifying and visualizing uncertainty in greater detail than the first means, and the testing means is capable of identifying and visualizing uncertainty in greater detail than the first means or the second means. In some embodiments, a second pattern technique is used by one or more means of the apparatus in modeling the business process. Some embodiments of the invention include a consolidation means for consolidating the modeling and or a decision toolbox having one or more tools for use with the model created. The first means may use a conceptual view, a data source definition view, a workflow view to create the high level model. The second means may use a domain model, calculation diagram, and/or a calculation script for modeling a calculation algorithm, The calculation diagram may have one or more layers and may be generated using the following steps: (i) defining global calculation parameters; (ii) defining one or more input variables and one or more output variables; (iii) defining the calculation algorithm; (iv) testing the calculation algorithm; and (v) generating a user interface form. The user interface form may include a dashboard. The testing means may tests the model using one or more sensitivity charts or a testing process diagram.

In another aspect of the invention, an apparatus for modeling a business process is provided, including (a) a first means for creating a high level model for the business process, (b) a second means for modeling a calculation algorithm for the business process; and (c) a testing means for testing the model; wherein one or more views are used by the first means, the second means and the testing means; and wherein the first means, the second means and the third means each use a pattern technique to identify and visualize uncertainty and wherein the second means is capable of identifying and visualizing uncertainty in greater detail than the first means, and the testing means is capable of identifying and visualizing uncertainty in greater detail than the first means or the second means, and wherein a second pattern technique is used by one or more means of the apparatus in modeling the business process. The apparatus of claim 74 wherein the first means uses a conceptual view to create the high level model. The first means may use a conceptual view, a data source definition view, a workflow view to create the high level model. The second means may use a domain model, calculation diagram, and/or a calculation script for modeling a calculation algorithm, The calculation diagram may have one or more layers and may be generated using the following steps: (i) defining global calculation parameters; (ii) defining one or more input variables and one or more output variables; (iii) defining the calculation algorithm; (iv) testing the calculation algorithm; and (v) generating a user interface form. The user interface form may include a dashboard. The testing means may tests the model using one or more sensitivity charts or a testing process diagram.

In another aspect of the invention, an apparatus for modeling a business process is provided, including (a) a first means for creating a high level model for the business process, (b) a second means for modeling a calculation algorithm for the business process; and (c) a testing means for testing the model; wherein one or more views are used by the first means, the second means and the testing means; and wherein the first means, the second means and the third means each use a pattern technique to identify and visualize uncertainty and wherein the second means is capable of identifying and visualizing uncertainty in greater detail than the first means, and the testing means is capable of identifying and visualizing uncertainty in greater detail than the first means or the second means, and wherein a tool from a decision toolbox is used, the tool may be, for example, a sensitivity analysis visual tool, a decision analysis tool (such a decision tree), a Monte Carlo simulation or a discrete simulation visualization.

In embodiments of the invention wherein an apparatus for modeling a business process is provided, including (a) a first means for creating a high level model for the business process, (b) a second means for modeling a calculation algorithm for the business process; and (c) a testing means for testing the model; wherein one or more views are used by the first means, the second means and the testing means; and wherein the first means, the second means and the third means each use a pattern technique to identify and visualize uncertainty and wherein the second means is capable of identifying and visualizing uncertainty in greater detail than the first means, and the testing means is capable of identifying and visualizing uncertainty in greater detail than the first means or the second means, and wherein a second pattern technique is used by one or more means of the apparatus in modeling the business process, the second pattern technique used may include decoupling, encapsulation, a user workflow visualization, or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a conceptual view, step b) of modeling a calculation algorithm for the business process is performed using a domain model, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a conceptual view, step b) of modeling a calculation algorithm for the business process is performed using a domain model, the step c) of testing the model is performed using a testing process diagram and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a conceptual view, step b) of modeling a calculation algorithm for the business process is performed using a calculation diagram, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a conceptual view, step b) of modeling a calculation algorithm for the business process is performed using a calculation diagram, the step c) of testing the model is performed using a testing process diagram and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a data source definition, step b) of modeling a calculation algorithm for the business process is performed using a domain model, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a data source definition view, step b) of modeling a calculation algorithm for the business process is performed using a domain model, the step c) of testing the model is performed using a testing process diagram and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a data source definition view, step b) of modeling a calculation algorithm for the business process is performed using a calculation diagram, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a data source definition view, step b) of modeling a calculation algorithm for the business process is performed using a calculation diagram, the step c) of testing the model is performed using a testing process diagram and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a workflow view, step b) of modeling a calculation algorithm for the business process is performed using a domain model, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a workflow view, step b) of modeling a calculation algorithm for the business process is performed using a domain model, the step c) of testing the model is performed using a testing process diagram and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a workflow view, step b) of modeling a calculation algorithm for the business process is performed using a calculation diagram, step c) of testing the model is performed using one or more sensitivity charts and the second pattern technique used during at least one step in the process may includes decoupling, encapsulation, a user workflow visualization and/or a multi-layer representation of calculation logic.

In some embodiments of the invention, comprising a method of creating models for a business process to help assess risk, including the steps of: (a) creating a high level model for the business process, (b) modeling a calculation algorithm for the business process; and (c) testing the model, in which one or more views are used in each of steps (a), (b) and (c); and in which the pattern technique of identifying and visualizing uncertainty is used in each of steps (a), (b) and (c), in increasing detail at each successive step a wherein step (a) includes a workflow definition view, step b) of modeling a calculation algorithm for the business process is performed using a calculation diagram, the step c) of testing the model is performed using a testing process diagram and the second pattern technique used during at least one step in the process may includes decoupling, encapsulation, a user workflow visualization and/or a multi-layer representation of calculation logic.

In another aspect of the invention, a program storage device readable by a machine, tangibly embodying a program of instructions executable by the machine to perform method steps for creating a model of a business process, is provided, said method steps comprising (a) creating a high level model for the business process, (b) modeling a calculation algorithm for the business process; and (c) testing the model, wherein one or more views are used in each of steps (a), (b) and (c); wherein a pattern technique of identifying and visualizing uncertainty is used in each of steps (a), (b) and (c), in increasing detail at each successive step, wherein the step a) of creating a high level model for the business process is performed using a conceptual view, wherein the step b) of modeling a calculation algorithm for the business process is performed using a domain model, a calculation diagram and/or a calculation script, and wherein the step c) of testing the model is performed using one or more sensitivity charts or a testing process diagram, and wherein the second pattern technique used during at least one step in the process includes decoupling, encapsulation, a user workflow visualization, or a multi-layer representation of calculation logic.

In another aspect of the invention, a program storage device readable by a machine, tangibly embodying a program of instructions executable by the machine to perform method steps for creating a model of a business process, is provided, said method steps comprising (a) creating a high level model for the business process, (b) modeling a calculation algorithm for the business process; and (c) testing the model, wherein one or more views are used in each of steps (a), (b) and (c); wherein a pattern technique of identifying and visualizing uncertainty is used in each of steps (a), (b) and (c), in increasing detail at each successive step, wherein the step a) of creating a high level model for the business process is performed using a data source definition view, wherein the step b) of modeling a calculation algorithm for the business process is performed using a domain model, wherein the step c) of testing the model is performed using one or more sensitivity charts and wherein the second pattern technique used during at least one step in the process includes decoupling, encapsulation, a user workflow visualization, or a multi-layer representation of calculation logic.

In another aspect of the invention, a program storage device readable by a machine, tangibly embodying a program of instructions executable by the machine to perform method steps for creating a model of a business process, is provided, said method steps comprising (a) creating a high level model for the business process, (b) modeling a calculation algorithm for the business process; and (c) testing the model, wherein one or more views are used in each of steps (a), (b) and (c); wherein a pattern technique of identifying and visualizing uncertainty is used in each of steps (a), (b) and (c), in increasing detail at each successive step, wherein the step a) of creating a high level model for the business process is performed using a workflow view, wherein the step b) of modeling a calculation algorithm for the business process is performed using a domain model, wherein the step c) of testing the model is performed using one or more sensitivity charts and wherein the second pattern technique used during at least one step in the process includes decoupling, encapsulation, a user workflow visualization, or a multi-layer representation of calculation logic.

In another aspect of the invention, a computer system for modeling a business process is provided, comprising a processor, at least one input device, and at least one output device, with program instructions being stored on a computer-readable media, the program instructions comprising the following steps: (a) creating a high level model for the business process, (b) modeling a calculation algorithm for the business process; and (c) testing the model; wherein one or more views are used in each of steps (a), (b) and (c); and wherein a pattern technique of identifying and visualizing uncertainty is used in each of steps (a), (b) and (c), in increasing detail at each successive step.

Other objects, features and advantages of the present invention will become apparent to those of skill in art by reference to the figures, the description that follows and the claims.

### BRIEF DESCRIPTION OF THE DRAWINGS

FIG. 1 depicts a flowchart of a preferred embodiment of the present invention.

FIG. 2 depicts views used for high level analysis of a business process in accordance with a preferred embodiment of the present invention.

FIG. 3 depicts views used for modeling the calculation algorithm step, in a preferred embodiment of the present invention.

FIG. 4 depicts an example of a domain model view, in a preferred embodiment of the present invention, for the economic evaluation of oil reserves.

FIG. 5 is a representation of layers of a calculation diagram, in accordance with a preferred embodiment of the present invention.

FIG. 6 depicts a flowchart for the process of generating a calculation diagram in a preferred embodiment of the present invention.

FIG. 7 depicts an example of the calculation diagram, according to a preferred embodiment of the present invention.

FIG. 8 depicts views of the step of model testing and analysis 60 in a preferred embodiment of the invention.

FIG. 9 depicts elements of the decision toolbox 80, used in accordance with a preferred embodiment of the present invention.

FIG. 10 depicts a more detailed version of the flowchart of FIG. 1.

FIG. 11 illustrates an example of the results of a simple testing process, in accordance with a preferred embodiment of the present invention.

FIG. 12 is a representation of use of a decoupling pattern of the modeling process used in accordance with a preferred embodiment of the present invention.

FIG. 13 is a representation of use of an encapsulation pattern of the modeling process used in accordance with a preferred embodiment of the present invention.

FIG. 14 is a representation of a user workflow visualization in accordance with a preferred embodiment of the present invention.

FIG. 15 depicts a multi-layer representation of calculation logic in accordance with a preferred embodiment of the present invention.

FIG. 16 illustrates early identification and visualization of uncertainties in a calculation model, in accordance with a preferred embodiment of the present invention.

### DETAILED DESCRIPTION OF THE DRAWINGS

In the following detailed description of the preferred embodiments and other embodiments of the invention, reference is made to the accompanying drawings. It is to be understood that those of skill in the art will readily see other embodiments and changes may be made without departing from the scope of the invention.

Patterns are named problem-solution formulas that codify exemplary modeling principles (see Larman, C., Applying UML and Patterns. 2nd Ed. Upper Saddle River, N.J.: Prentice-Hall, Inc., 2002, incorporated herein by reference). Patterns also can be referred to as tried-and-true solutions to modeling problems expressed as best-practice principles. Patterns are widely used in the software development and workflow management as discussed in van der Aaltst and van Hee, Workflow management: Models, Methods, and Systems, Cambridge, Mass., MIT Press, 2004, as a way to capture best practices for design and analysis. However, patterns so far have not been extensively used in modeling of business problems.

Some important patterns are common for different workflows and applications. Patterns are usually presented in the form of problem-solution description. The present invention uses a visual modeling workflow. A diagram or a group of diagrams represent each step within this workflow. The visual modeling process can be simplified by applying patterns or problem-solution formulas. Such modeling patterns include decoupling, encapsulation, visualization of user workflow, multi-layer visual representation of the calculation logic, and early identification and visualization of uncertainties. These techniques are further described herein. The patterns are applied to the visual modeling workflow, which include high level conceptual modeling, using domain models and calculation diagrams to visualize the calculation logic, visualization of testing and consolidations, and visualization of results of probabilistic analysis and simulation.

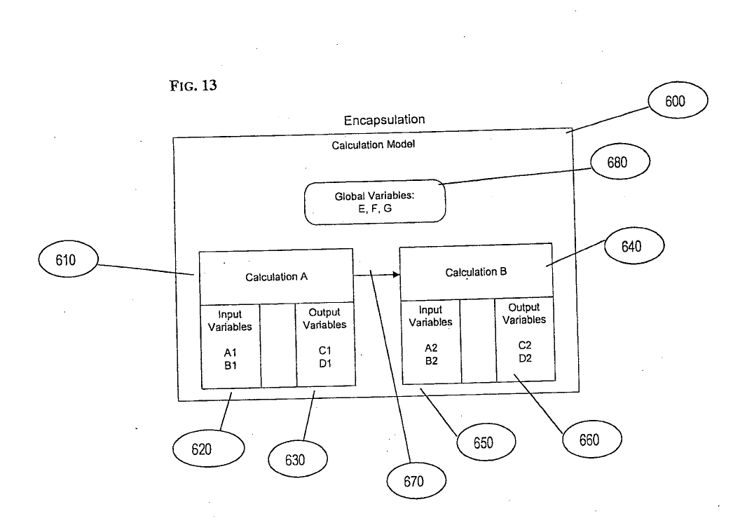

Pattern techniques are further discussed below and are illustrated in FIGS. 13-17.

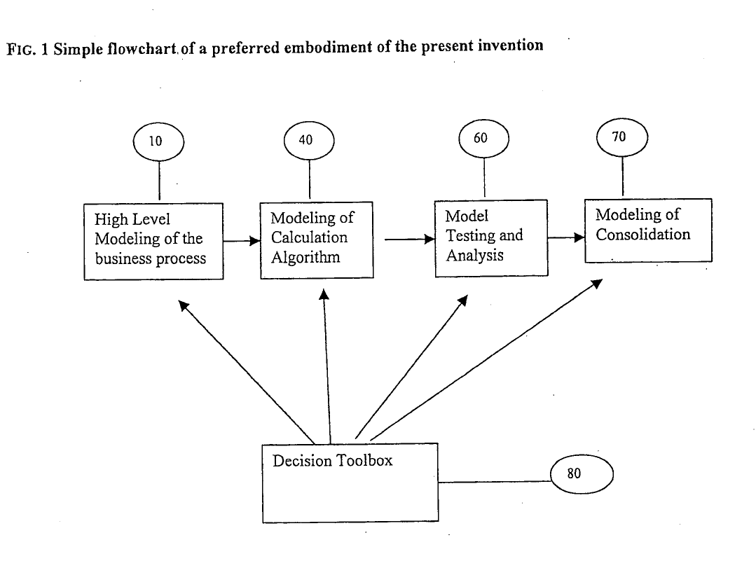

FIG. 1 depicts a simple flowchart of a preferred embodiment of the present invention. The first step in the process is a high level analysis of business processes 10. The high level of analysis of business processes step may include identifying problem and opportunities, assessing the business situation, generating creative alternatives, and providing a high level modeling of the business situation.

The next step is modeling of a calculation algorithm 40. The third step is model testing and analysis, 60 and the fourth step, which is optional, is consolidation 70. A decision toolbox 80 is provided for use with the model created by the process of the present invention. Each of these steps is described in more detail herein. In addition, uncertainties involved in the business process are identified and visualized at the each of the high level of analysis of business processes step 10, the modeling of a calculation algorithm step 40 and the model testing and analysis step 60. Pattern techniques may be applied throughout the process or at one or more points of the process.

Pattern Techniques

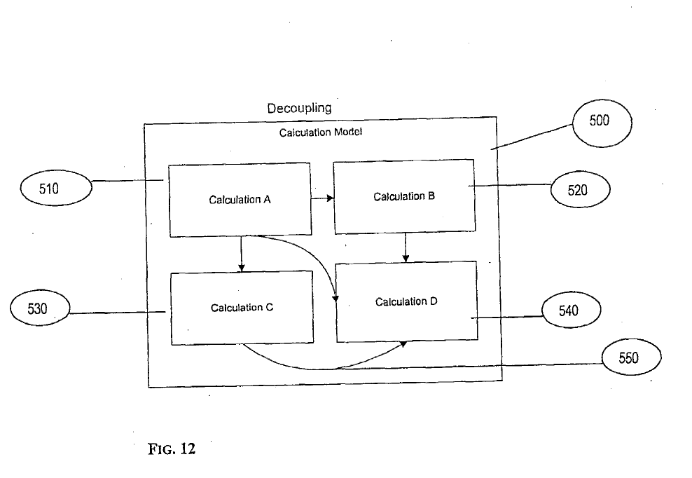

Pattern techniques are described in this section and are represented in FIGS. 12-16.

The modeling pattern of decoupling helps address the problem of simplifying complex models. Such models are often comprised of multiple independent calculations, which are linked together and as such, are difficult to analyze and test. A solution in accordance with a preferred embodiment of the present invention is to analyze dependencies between calculations. It is important to know what variables are common between different calculations and what output variables are the inputs for the next calculation. The number of such links between calculations should be minimized. Each calculation should be tested separately if it is possible. Decoupling is closely related to visualization: each calculation can be presented separately on a visual diagram. For example, operating cost calculation includes many variables but only total operating cost time series would generally be used for the next step in the calculation of project's net present value. FIG. 12 is a representation of a use 500 of a decoupling pattern of the modeling process used in accordance with a preferred embodiment of the present invention. In the representation of FIG. 12, four calculations are depicted: Calculation A 510, Calculation B 520, Calculation C 530 and Calculation D 540. Arrows such as arrow 550, indicate relationships among the calculations.

If the model has a large number of variables it complicates the analysis and testing. A solution in accordance with a preferred embodiment of the present invention is encapsulation, which means not exposing information about intermediate variables to other calculations. An example of encapsulation is a calculation of product revenue. Internal calculation of the revenue includes a number of intermediate variables. These internal variables will not visible or accessible from any other calculations. FIG. 13 is a representation of a use 600 of an encapsulation pattern of the modeling process used in accordance with a preferred embodiment of the present invention. In the representation of FIG. 13, two calculations are depicted, along with their input and output variables: Calculation A 610, having input variables 620 A1 and B1 and output variables 630 C1 and D1, and Calculation B 640, having input variables 650 A2 and B2 and output variables 660 C2 and D2. Note the relationship arrow 670 between Calculation A 610 and Calculation B 620. The global variables 680 E, F and G are encapsulated (depicted without arrows), so that information about the global variables 680 is not shared by Calculation B. Global variables, also called “global parameters” or “global calculation parameters,” are variables used by all the calculations in the model. Other (“local”) variables are used by one or more specific calculations in the model.

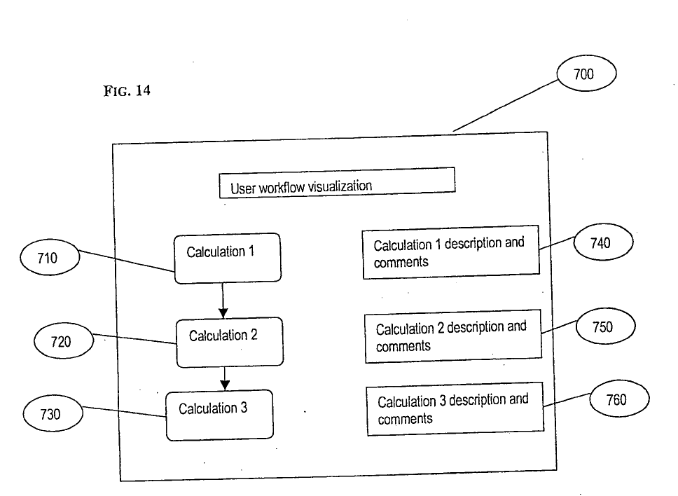

Another problem in the modeling process is how to simplify the user interaction with the model, especially when model has a large number of variables with relationships to each other that are not obvious. A solution in accordance with a preferred embodiment of the present invention is to present the user with a user workflow visualization, which is a system of steps to be followed to use the model, presented in a user or run-time workflow view. For example, information about sequential calculation of sales, revenue, costs, and NPV can be presented within a user interface in the form of a user workflow chart, arranged in an order that makes sense to the user. FIG. 14 is a representation of a user workflow visualization 700 in accordance with a preferred embodiment of the present invention. Note that three sequential calculations, as indicated by the arrows, Calculation 1 710, Calculation 2 720 and Calculation 3 730, are presented in a user or run-time workflow view. A “view” is a visualization of the model or a visualization of a particular aspect of the model. Descriptions and comments for each calculation (740, 750, 760) are also presented, in a manner convenient to the user.

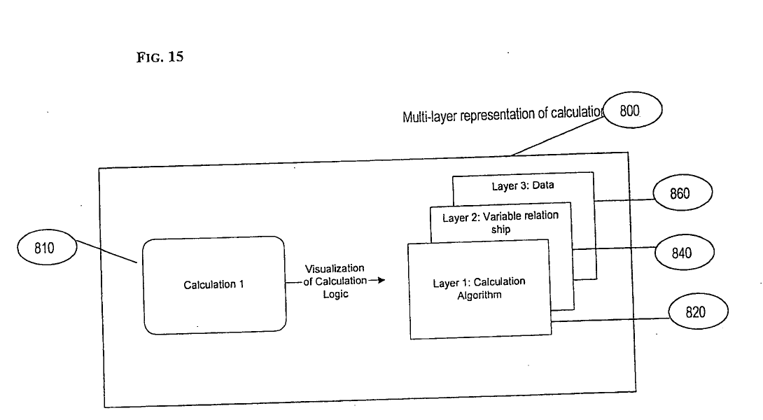

It is desirable to use visual tools to represent the calculation logic of a model. However, a single universal solution for simple visualization of calculation logic is not available. According to a pattern of multi-layer representation of calculation logic, calculation logic for one model can be represented by different views and each view can have multiple layers. Layers represent information that can be shown or hidden for the particular view. For example, a calculation algorithm with time series data can be represented by block diagrams in one layer and in a spreadsheet-type view, with testing data associated with the calculation in another layer. FIG. 15 depicts a multi-layer representation of calculation logic 800 in accordance with a preferred embodiment of the present invention. In the representation of FIG. 15, Calculation 1 810 is represented in three layers: Layer 1 820 for a calculation algorithm, Layer 2 830 for variable relationship and Layer 3 840 for data.

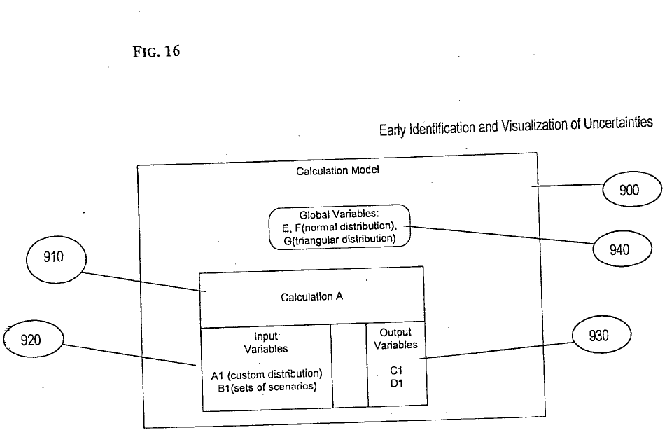

Another modeling pattern is early identification and visualization of uncertainties. Most business processes include analysis of uncertainties. Identification of uncertainties and their properties is an important but complicated process. A solution in accordance with a preferred embodiment of the present invention is to identify and visualize the uncertainties on all stages (the first three steps of a preferred embodiment of the present invention) of the modeling workflow, starting from a conceptual design of the model. For example, if it were determined that a capital cost is an uncertain parameter affecting net present value of a project, then the uncertainty in that capital cost should be visualized on calculation, testing, consolidation, and other diagrams. FIG. 16 illustrates early identification and visualization of uncertainties in a calculation model 900, in accordance with a preferred embodiment of the present invention. In FIG. 16, Calculation A 910 is depicted having input variables 920 A1 and B1 and output variables 930 C1 and D1. FIG. 16 illustrates early identification and visualization of uncertainties of the modeling process 900. In FIG. 16, Calculation A 910 is depicted having input variables 920 A1 and B1 and output variables 930 C1 and D1. As indicated in FIG. 16, uncertainties in input variable A1 are expressed using a custom distribution. Uncertainties in input variable B1 are expressed as a set of scenarios. Of the global variables 940, E is deterministic; uncertainties in variable F are expressed using normal distribution, while uncertainties in global variable G are expressed using triangular distribution. This example illustrates early identification of uncertainties at the stage of modeling. Particular distribution parameters may be defined during simulation and analysis of the models.

Details of the Modeling Process

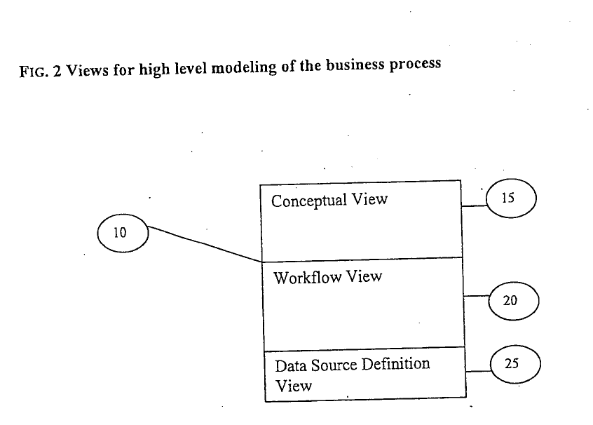

FIG. 2 depicts three views of the high level analysis of business processes 10 of the present invention. A conceptual view 15 represents a relationship between different calculations (or processes) and simulation methods. The conceptual view 15 may be, for example:

a. Hierarchical (which may include sub-processes)

b. Location-based—for location-based problems

c. Time-based—for processes relating to time

d. Generic—general description of relationship between processes

A workflow view 20 is a graphical representation of an order of an automatic generation of sequential diagrams. The workflow view 20 also represents an order of calculation/simulation. At least two possible processes may be presented by a workflow view 20: a model building process or a run-time simulation/calculation process. The modeling workflow view is the mapping of the general workflow to the particular business process. This is workflow for the modeler. The calculation and simulation workflow view is intended to be for the user of the model. The workflow view 20 for run-time simulation and calculation may include data input dashboards and reports representation. Dashboards are user interface forms to input data.

A Data Source Definition view (DSDV) 25 may include graphical representations of data sources, high level definitions of input and output variables and their relationship with calculations and simulation methods. Data sources may include databases, spreadsheets, application data inputs, and the results of previous calculations.

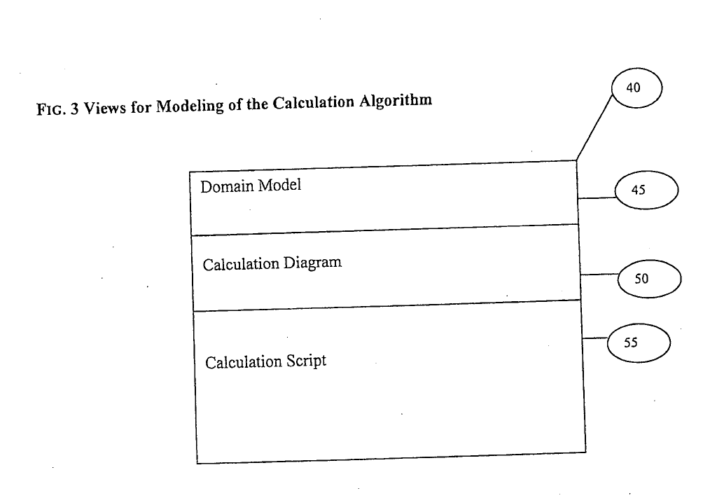

The second step in creating a model is the detailed modeling 40 of the business process. FIG. 3 depicts the detailed modeling 40 step, in a preferred embodiment of the present invention, which can be represented by at least three views: a calculation script 55, a calculation diagram 50, and a domain model view 45. Some advanced business analysis and simulation frameworks use scripting languages to define calculation algorithms using easy-to-use notation. Scripting languages provide access to model variables and functions.

A domain model view 45 provides a structural decomposition of the model. The domain model view 45 separates the model into its calculations and presents input and output variables for each calculation. A calculation diagram 50 is one of most important concepts of visual modeling workflow, being used to visualize a calculation algorithm and its associated data. The most time-consuming step in the modeling process is the visualization of calculation algorithm. The domain model view 45 is one of the views useful in this step. Both the calculation diagram 50 and the domain model view 45 are discussed further herein.

Referring again to FIG. 3, the calculation script 55 defines the model using some sort of scripting language. The calculation script 55 provides the access to input and output model variables. The scripting language includes variables, conditions, loops, and mathematical calculations. Use of the calculation script 55 is very flexible way to define the model. However scripting language is not intuitive enough for the inexperienced modeler, therefore, the calculation script 55 should preferably be augmented by other views, such as calculation diagram 50 and/or the domain model 45.

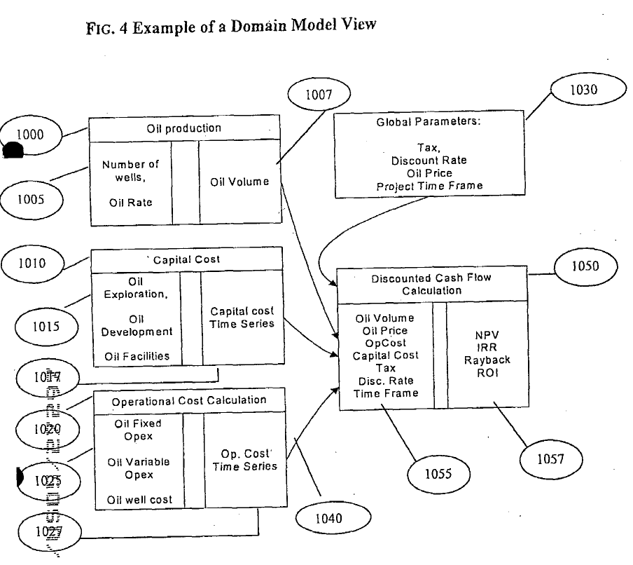

In a preferred embodiment of the present invention, the domain model 45 is represented by a diagram having a number of boxes. Making use of the encapsulation and decoupling patterns, each box represents a calculation, global parameters, or inputs used in calculations. Each calculation box has two or three columns. The left column depicts calculation inputs, the right column depicts calculation outputs, and the middle column is optional and may depict intermediate variables. Particular calculation formulas are generally not represented within a domain model. An example of a domain model 45, in a preferred embodiment of the present invention, for the economic evaluation of oil reserves is presented in FIG. 4. FIG. 4 depicts calculations, such as an oil production calculation 1000 having inputs 1005 (number of wells and oil rate) and an output 1007 (oil volume), a capital cost calculation 1010 having inputs 1015 (oil exploration cost, oil development cost and oil facilities cost) and output 1017 (capital cost time series), and an operational cost calculation 1020 having inputs 1025 (oil fixed opex, oil variable opex, and oil well cost) and output 1027 (operational cost time series). FIG. 4 also depicts global parameters 1030 (tax, discount rate, oil price, and project time frame). As indicated by the arrows, such as arrow 1040, the outputs 1007, 1017, 1027 from calculations 1000, 1010,1020 and the global parameters 1030 feed into the discounted cash flow calculation 1050 as inputs 1055. FIG. 4 also depicts the outputs 1057 of the discounted cash flow calculation 1050.

Referring again to FIG. 3, the calculation diagram 50 represents the calculation algorithm by combining the advantages of flow charts, spreadsheet representations, and scripting languages. The calculation diagram 50 presents both the calculation algorithm and associated testing data together. The data within the calculation diagram 50 is testing data, used by the modeler to determine if the calculation algorithm is defined correctly. The calculation diagram 50 also includes relationships between variables, in a form similar to that of a block diagram. Because this is primarily an intermediate diagnostic tool, the end user may not necessarily see this view. Instead, the user form or a dashboard may be used to interface with the end user.

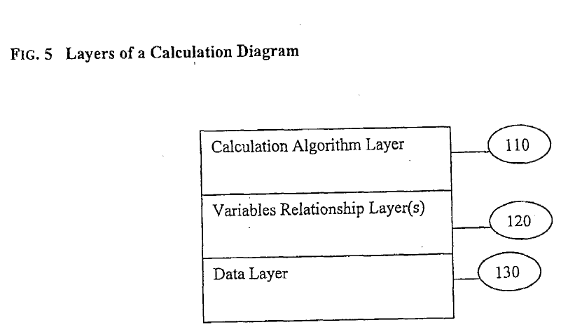

The calculation diagram 50 can become be very crowded, so the information can be separated into layers (according to the “Multi-Layer Representation of Calculation Logic” pattern technique), such as the three layers depicted in FIG. 5: a calculation algorithm layer 110, one or more variables relationship layers 120, and a data layer 130. (Both diagrams and views can be separated into layers.) The calculation algorithm layer 110 may include variables and calculation expressions. The variables relationship layer(s) 120, may include precedents and/or dependent arrows between input, output, and/or intermediate variables. Using more than one variables relationship layer can be particularly useful for complex diagrams with a large number of variables. The data layer 130 includes data associated with variables. Each layer can be presented separately or together with other layers.

The calculation diagram 50 is designed to operate with different data formats, or data shapes. Data shapes, as distinct from data types (discussed below), can include scalars, vectors, and matrixes. Business analysis applications operate mostly with scalars and time series (vector) data shapes.

In business modeling, the definition of data types is much broader then in computer programming, where the data types may include double, integer, and other such types. Data types in business models generally represent the nature of the variable. For example, data types in business models may include costs, revenues, prices, taxes, dates, etc. Use of data types provides an additional level of control for the model. For example, if the modeler makes a mistake and adds units sold to a cost, the modeling framework will easy identify the problem as long as the units sold variable and the cost variable have different data types. Data type analysis can be very beneficial when consolidation of results of business analysis from different sources is required. Available data types may be predefined for the model or for a group of models.

Another characteristic of variables is that they can be input variables, output variables, or intermediate variables. Input variables may have dependants but do not have precedents. Output variables may have precedents but do not have dependants. Intermediate variables have both precedents and dependants, and, unlike input variables and output variables, are generally not presented to the user within a user interface form.

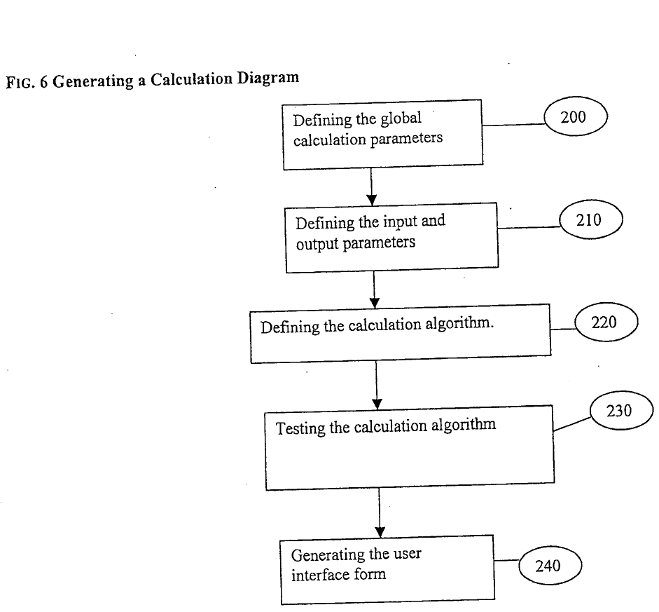

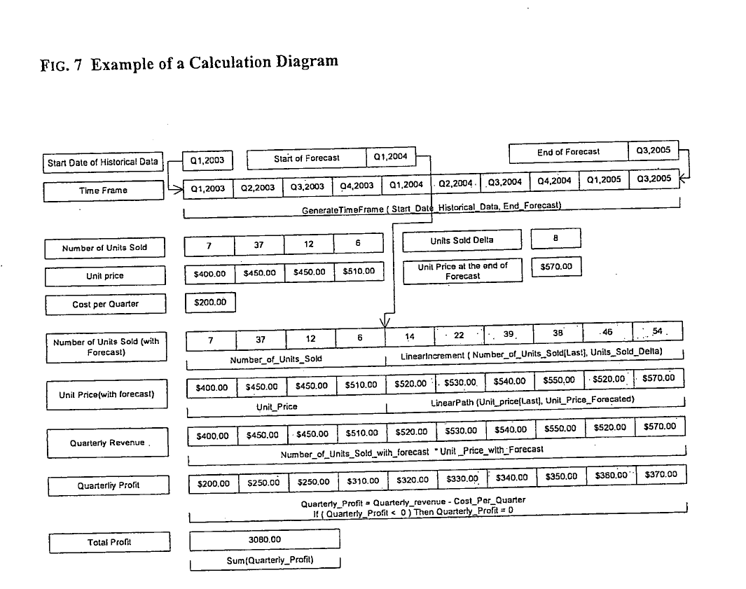

As depicted in FIG. 6, generation of the calculation diagram 50 in a preferred embodiment of the present invention includes the following steps:
a. Define 200 global calculation parameters. The global calculation parameters could include units, currencies, periodicity, tax rates, discount rates, etc. An example of the calculation diagram, according to a preferred embodiment of the present invention, is shown in FIG. 7. In FIG. 7, the global calculation parameters are “Start Date of Historical Data”, “End of forecast”, and the quarterly periodicity. The global calculation parameters may also be used to define the time frame of the calculation, which is used for all subsequent calculations.
b. Define 210 the input and output parameters. The purpose of the calculation for the example shown on FIG. 7 is to calculate total profit based on number of units sold, unit price, and cost per quarter. The calculation uses one-year of historical data plus forecasted data. Properties (such as external name of variable, internal name of variable, shape, and data type) for each variable must be assigned. Static elements of the diagram, such as rectangles with the external name of the variables can be defined. Input, output, and intermediate variables can be represented by different colors.
c. Define 220 the calculation algorithm. The calculation is performed using standard and/or custom functions. Standard functions are commonly used calculations and manipulation. Custom functions are typically developed by the user, using a scripting language. The relationship between variables is represented using connector lines with arrows. Connectors in current examples are used to represent the generation of the time frame based on three input dates.
d. Test 230 the calculation algorithm. Because testing data and the calculation algorithm are presented within one calculation diagram, the analysis and testing of the algorithm is simpler. Each change in the calculation algorithm can be automatically reflected in the test data output. By graphing intermediate and output data from the calculation diagram the modeler can more easily identify potential problems.
e. Generate 240 a user interface form (such as a dashboard). One of the main advantages of the calculation diagram is that user input form can be generated semi-automatically. The modeler generates an input form using calculation diagram by hiding the calculation algorithm, intermediate variables, and possibly connectors, which represent relationships between variables. Also some input controls can be moved or updated to simplify user input. Static text and charts can then be added to the control.

Advantages of the calculation diagram 50 may include the following:
a. The calculation diagram 50 presents data, calculations, and relationship between variables on the different layers within the same document, simplifying analysis of the model.
b. The calculation diagram 50 is based on combination of standard flow chart format and spreadsheet-style data representations, which are modeling techniques familiar to most modelers. This familiarity can significantly reduce a user's learning curve.
c. The calculation diagram 50 significantly simplifies operation with time series data, which are very common in business analysis.
d. The user input forms can be easily generated using the calculation diagram 50.

One of main challenges in the modeling of the business problems is to provide the modeler with testing and data analysis tools. Even with very advanced visual modeling tools, the modeler may have problems with capturing user requirements or may make an error in the modeling process. Most business models can be very complicated which significantly increases the chance for errors. Such problems sometimes cannot be detected using limited sets of testing data. Analysis of multiple different combinations of input parameters is useful.

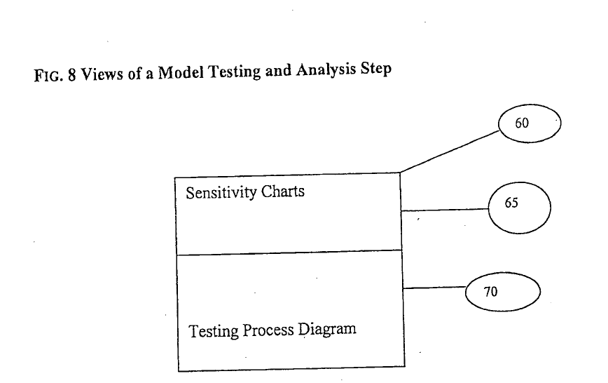

FIG. 8 depicts views of the step of model testing and analysis 60 in a preferred embodiment of the invention. The model testing and analysis step 60 includes two views: the testing process diagram 70 and a sensitivity chart view 65. The testing process diagram 70 is related to the Data Source Definition view (DSDV) 25 for the particular testing process used. The testing process diagram 1270 preferably includes data sources and data ranges for all variables. The sensitivity chart 65 is used to represent ranges of input testing data together with ranges of outputs.

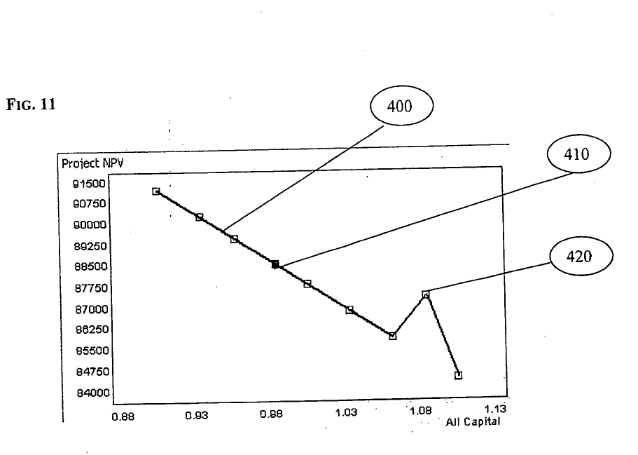

To test the model, the business analysis solution framework should provide calculations for all requested combinations of inputs ranges. An example of the results 400 of a simple testing process is illustrated in FIG. 11. The project NPV is calculated based on different data associated with variable “All Capital.” All other variables will have base value. A known solution 410 is presented as a red dot on the chart. A spike, such as spike 420, in a chart may be associated with an error in the model. Because possible number of requested calculations for all variables can be huge, the chart does not always need to be generated. But a solution framework can inform the modeler about any unexpected non-linearity in the dependencies between input and output variables.

Referring back to FIG. 1, the final, and optional, step in the business modeling process is modeling consolidation 70 using one or more consolidation diagrams. The consolidation diagrams visually present relationships between different calculations within a model. In most cases, complex business processes may be represented by multiple calculations within a model. The consolidated diagram of overall business process will include some output variables of the calculations. The consolidation diagrams depict how output variables of separate calculations will be used in the model. For example, NPV is calculated on three phases of project; each phase is represented by its own calculation. Consolidation diagram will represent these three calculations and show that overall NPV will be calculated as a sum of NPVs of the separate calculations.

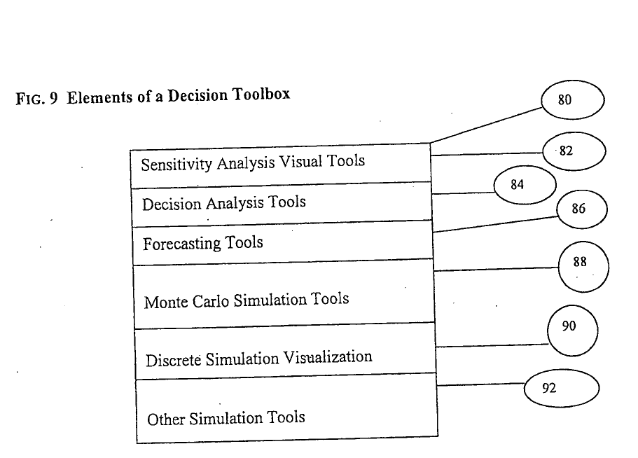

FIG. 9 depicts elements of the decision toolbox 80, which may be used in accordance with a preferred embodiment of the present invention. The elements may include sensitivity analysis visual tools 82, decision analysis tools 84 such as decision trees, forecasting tools 86, Monte Carlo simulation tools 88, discrete simulation visualization 90, and other simulation tools 92. The decision toolbox 80 and the tools included therein are not used in the modeling process but may be used to perform analysis and simulation using the model created in the modeling process (steps 10, 40, 60 and 70 of FIG. 1).

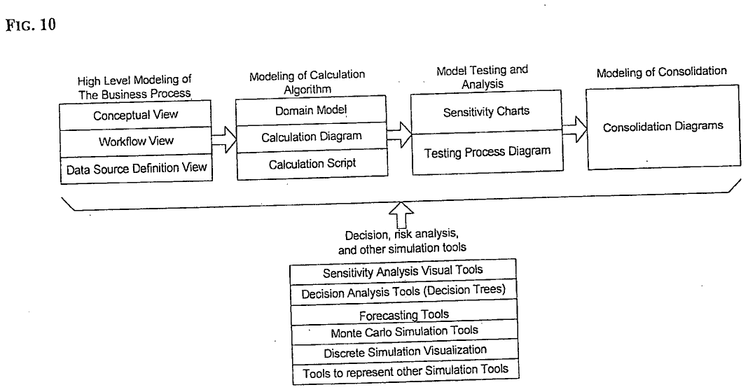

FIG. 10 depicts a more detailed version of FIG. 1, illustrating the different views associated with each step (as previously discussed) and the different elements in the decision toolbox.

Although the foregoing is provided for purposes of illustrating, explaining and describing certain embodiments of invention in particular detail, modifications and adaptations to the described methods, systems and other embodiments will be apparent to those skilled in the art and may be made without departing from the scope or spirit of the invention.

1. A method of modeling a business process to assess risk, comprising the steps of:
a) creating a high level model for the business process,
b) modeling a calculation algorithm for the business process; and
c) testing the model;
wherein one or more views are used in each of steps (a), (b) and (c);
and wherein the pattern technique of identifying and visualizing uncertainty is used in each of steps (a), (b) and (c), in increasing detail at each successive step.

2. The method of claim 1 wherein at least a second pattern technique is used during at least one of steps (a), (b) and (c) of the process.

3. The method of claim 1 further comprising the step of consolidating the model.

4. The method of claim 1 further comprising the step of using one or more tools from a decision toolbox with the model created.

5. The method of claim 1 wherein the step a) of creating the high level model for the business process is performed using a conceptual view.

6. The method of claim 1 wherein the step a) of creating the high level model for the business process is performed using a data source definition view.

7. The method of claim 1 wherein the step a) of creating the high level model for the business process is performed using a workflow view.

8. The method of claim 1 wherein the step b) of modeling a calculation algorithm for the business process is performed using a domain model view.

9. The method of claim 1 wherein the step b) of modeling a calculation algorithm for the business process is performed using a calculation diagram.

10. The method of claim 9 wherein the calculation diagram has one or more layers.

11. The method of claim 9 wherein the calculation diagram used is generated using the following steps:
i) defining global calculation parameters;
ii) defining one or more input variables and one or more output variables;
iii) defining the calculation algorithm;
iv) testing the calculation algorithm; and,
v) generating a user interface form.

12. The method of claim 11 wherein the user interface form comprises a dashboard.

13. The method of claim 1 wherein the step b) of modeling a calculation algorithm for the business process is performed using a calculation script.

14. The method of claim 13 wherein the step b) of modeling a calculation algorithm for the business process by using a calculation script is performed by also using a domain script.

15. The method of claim 13 wherein the step b) of modeling a calculation algorithm for the business process by using a calculation script is performed by also using a calculation diagram.

16. The method of claim 1 wherein the step c) of testing the model is performed using one or more sensitivity charts.

17. The method of claim 1 wherein the step c) of testing the model is performed using a testing process diagram.

18. The method of claim 2 wherein the step a) of creating the high level model for the business process is performed using a conceptual view.

19. The method of claim 2 wherein the step a) of creating the high level model for the business process is performed using a data source definition view.

20. The method of claim 2 wherein the step a) of creating the high level model for the business process is performed using a workflow view.

21. The method of claim 2 wherein the step b) of modeling a calculation algorithm for the business process is performed using a domain model.

22. The method of claim 2 wherein the step b) of modeling a calculation algorithm for the business process is performed using a calculation diagram.

23. The method of claim 22 wherein the calculation diagram has one or more layers.

24. The method of claim 22 wherein the calculation diagram used is generated using the following steps:
i) defining global calculation parameters;
ii) defining one or more input variables and one or more output variables;
iii) defining the calculation algorithm;
iv) testing the calculation algorithm; and
v) generating a user interface form.

25. The method of claim 2 wherein the step b) of modeling a calculation algorithm for the business process is performed using a calculation script.

26. The method of claim 2 wherein the step c) of testing the model is performed using one or more sensitivity charts.

27. The method of claim 2 wherein the step c) of testing the model is performed using a testing process diagram.

28. The method of claim 4 wherein one of the tools from the decision toolbox used is a sensitivity analysis visual tool.

29. The method of claim 4 wherein one of the tools from the decision toolbox used is a decision analysis tool.

30. The method of claim 29 wherein the decision analysis tool is a decision tree.

31. The method of claim 4 wherein one of the tools from the decision toolbox used is a Monte Carlo simulation.

32. The method of claim 4 wherein one of the tools from the decision toolbox used is a discrete simulation visualization.

33. The method of claim 2 wherein the second pattern technique used during at least one step in the process includes decoupling.

34. The method of claim 2 wherein the second pattern technique used during at least one step in the process includes encapsulation.

35. The method of claim 2 wherein the second pattern technique used during at least one step in the process includes a user workflow visualization.

36. The method of claim 2 wherein the second pattern technique used during at least one step in the process includes a multi-layer representation of calculation logic.

37. A program storage device readable by a machine, tangibly embodying a program of instructions executable by the machine to perform method steps for creating a model of a business process, said method steps comprising:
a) creating a high level model for the business process,
b) modeling a calculation algorithm for the business process; and
c) testing the model;
wherein one or more views are used in each of steps (a), (b) and (c); and
wherein a pattern technique of identifying and visualizing uncertainty is used in each of steps (a), (b) and (c), in increasing detail at each successive step.

38. The program storage device of claim 37 wherein at least a second pattern technique is used during at least one step of the process.

39. The program storage device of claim 37, wherein the method steps further comprise the step of consolidating the model.

40. The program storage device of claim 37, wherein the method steps further comprise the step of using one or more tools from a decision toolbox with the model created.

41. The program storage device of claim 37 wherein the step a) of creating a high level model for the business process is performed using a conceptual view.

42. The program storage device of claim 37 wherein the step a) of creating a high level model for the business process is performed using a data source definition view.

43. The program storage device of claim 37 wherein the step a) of creating a high level model for the business process is performed using a workflow view.

44. The program storage device of claim 37 wherein the step b) of modeling a calculation algorithm for the business process is performed using a domain model.

45. The program storage device of claim 37 wherein the step b) of modeling a calculation algorithm for the business process is performed using a calculation diagram.

46. The program storage device of claim 45 wherein the calculation diagram used has one or more layers.

47. The program storage device of claim 45 wherein the calculation diagram used is generated using the following steps:
i) defining global calculation parameters;
ii) defining one or more input variables and one or more output variables;
iii) defining the calculation algorithm;
iv) testing the calculation algorithm; and
v) generating a user interface form.

48. The program storage device of claim 47 wherein the user interface form comprises a dashboard.

49. The program storage device of claim 37 wherein the step b) of modeling a calculation algorithm for the business process is performed using a calculation script.

50. The program storage device of claim 49 wherein the step b) of modeling a calculation algorithm for the business process by using a calculation script is performed by also using a domain script.

51. The program storage device of claim 49 wherein the step b) of modeling a calculation algorithm for the business process by using a calculation script is performed by also using a calculation diagram.

52. The program storage device of claim 37 wherein the step c) of testing the model is performed using one or more sensitivity charts.

53. The program storage device of claim 37 wherein the step c) of testing the model is performed using a testing process diagram.

54. The program storage device of claim 38 wherein the step a) of creating a high level model for the business process is performed using a conceptual view.

55. The program storage device of claim 38 wherein the step a) of creating a high level model for the business process is performed using a data source definition view.

56. The program storage device of claim 38 wherein the step a) of creating a high level model for the business process is performed using a workflow view.

57. The program storage device of claim 38 wherein the step b) of modeling a calculation algorithm for the business process is performed using a domain model.

58. The program storage device of claim 38 wherein the step b) creating a second model for a calculation algorithm for the business process is performed using a calculation diagram.

59. The program storage device of claim 58 wherein the calculation diagram used has one or more layers.

60. The program storage device of claim 58 wherein the calculation diagram used is generated using the following steps:
i) defining global calculation parameters;
ii) defining one or more input variables and one or more output variables;
iii) defining the calculation algorithm;
iv) testing the calculation algorithm; and
v) generating a user interface form.

61. The program storage device of claim 38 wherein the step b) of modeling a calculation algorithm for the business process is performed using a calculation script.

62. The program storage device of claim 38 wherein the step c) of testing the model is performed using one or more sensitivity charts.

63. The program storage device of claim 38 wherein the step c) of testing the model is performed using a testing process diagram.

64. The program storage device of claim 40 wherein one of the tools from the decision toolbox used is a sensitivity analysis visual tool.

65. The program storage device of claim 40 wherein one of the tools from the decision toolbox used is a decision analysis tool.

66. The program storage device of claim 65 wherein the decision analysis tool is a decision tree.

67. The program storage device of claim 40 wherein one of the tools from the decision toolbox used is a Monte Carlo simulation.

68. The program storage device of claim 40 wherein one of the tools from the decision toolbox used is a discrete simulation visualization.

69. The program storage device of claim 38 wherein the second pattern technique used during at least one step in the process includes decoupling.

70. The program storage device of claim 38 wherein the second pattern technique used during at least one step in the process includes encapsulation.

71. The program storage device of claim 38 wherein the second pattern technique used during at least one step in the process includes a user workflow visualization.

72. The program storage device of claim 38 wherein the second pattern technique used during at least one step in the process includes a multi-layer representation of calculation logic.

73. An apparatus for modeling a business process comprising:
a) a first means for creating a high level model for the business process,
b) a second means for modeling a calculation algorithm for the business process; and
c) a testing means for testing the model;
wherein one or more views are used by the first means, the second means and the testing means; and
wherein the first means, the second means and the third means each use a pattern technique to identify and visualize uncertainty and wherein the second means is capable of identifying and visualizing uncertainty in greater detail than the first means, and the testing means is capable of identifying and visualizing uncertainty in greater detail than the first means or the second means.

74. The apparatus of claim 73 wherein a second pattern technique is used by one or more means of the apparatus in modeling the business process.

75. The apparatus of claim 73 further comprising a consolidation means for consolidating the model.

76. The apparatus of claim 73 further comprising a decision toolbox having one or more tools for use with the model created.

77. The apparatus of claim 73 wherein the first means uses a conceptual view to create the high level model.

78. The apparatus of claim 73 wherein the first means uses a data source definition view to create the high level model.

79. The apparatus of claim 73 wherein the first means uses a workflow view to create the high level model.

80. The apparatus of claim 73 wherein the second means uses a domain model for modeling a calculation algorithm.

81. The apparatus of claim 73 wherein the second means uses a calculation diagram for modeling a calculation algorithm.

82. The apparatus of claim 81 wherein the calculation diagram has one or more layers.

83. The apparatus of claim 81 wherein the calculation diagram used is generated using the following steps:
i) defining global calculation parameters;
ii) defining one or more input variables and one or more output variables;
iii) defining the calculation algorithm;
iv) testing the calculation algorithm; and
v) generating a user interface form.

84. The apparatus of claim 83 wherein the user interface form comprises a dashboard.

85. The apparatus of claim 73 wherein the second means uses a calculation script for modeling a calculation algorithm.

86. The apparatus of claim 85 wherein the second means also uses a domain model for modeling a calculation algorithm.

87. The apparatus of claim 85 wherein the second means also uses a calculation diagram for modeling a calculation algorithm.

88. The apparatus of claim 73 wherein testing means tests the model using one or more sensitivity charts.

89. The apparatus of claim 73 wherein testing means tests the model using a testing process diagram.

90. The apparatus of claim 74 wherein the first means uses a conceptual view to create the high level model.

91. The apparatus of claim 74 wherein the first means uses a data source definition view to create the high level model.

92. The apparatus of claim 74 wherein the first means uses a workflow view to create the high level model.

93. The apparatus of claim 74 wherein the second means uses a domain model for modeling a calculation algorithm for the business process.

94. The apparatus of claim 74 wherein the second means uses a calculation diagram for modeling a calculation algorithm for the business process.

95. The apparatus of claim 94 wherein the calculation diagram has one or more layers.

96. The apparatus of claim 94 wherein the calculation diagram used is generated using the following steps:
i) defining global calculation parameters;
ii) defining one or more input variables and one or more output variables;
iii) defining the calculation algorithm;
iv) testing the calculation algorithm; and
v) generating a user interface form.

97. The apparatus of claim 74 wherein the second means uses a calculation script for modeling a calculation algorithm for the business process.

98. The apparatus of claim 74 wherein the testing means for testing the model uses one or more sensitivity charts.

99. The apparatus of claim 74 wherein the testing means for testing the model uses a testing process diagram.

100. The apparatus of claim 76 wherein one of the tools from the decision toolbox is a sensitivity analysis visual tool.

101. The apparatus of claim 76 wherein one of the tools from the decision toolbox is a decision analysis tool.

102. The apparatus of claim 101 wherein the decision analysis tool is a decision tree.

103. The apparatus of claim 76 wherein one of the tools from the decision toolbox is a Monte Carlo simulation.

104. The apparatus of claim 76 wherein one of the tools from the decision toolbox is a discrete simulation visualization.

105. The apparatus of claim 74 wherein the second pattern technique used by one or more means of the apparatus includes decoupling.

106. The apparatus of claim 74 wherein the second pattern technique used by one or more means of the apparatus includes encapsulation.

107. The apparatus of claim 74 wherein the second pattern technique used by one or more means of the apparatus includes a user workflow visualization.

108. The apparatus of claim 74 wherein the second technique used by one or more means of the apparatus includes a multi-layer representation of calculation logic.

109. The program storage device of claim 55 wherein the step b) of modeling a calculation algorithm for the business process is performed using a calculation diagram, wherein the step c) of testing the model is performed using a testing process diagram and wherein the second pattern technique used during at least one step in the process includes decoupling.

110. A computer system for modeling a business process, comprising a processor, at least one input device, and at least one output device, with program instructions being stored on a computer-readable media, the program instructions comprising the following steps:
a) creating a high level model for the business process,
b) modeling a calculation algorithm for the business process; and
c) testing the model;
wherein one or more views are used in each of steps (a), (b) and (c); and
wherein a pattern technique of identifying and visualizing uncertainty is used in each of steps (a), (b) and (c), in increasing detail at each successive step.
